(19) United States
(12) Patent Application Publication
(10) Pub. No.: US 2013/0166498 A1
(43) Pub. Date: Jun. 27, 2013

(54) Model Based OLAP Cube Framework

(71) Applicants: Vijay Aski, Bellevue, WA (US); Danny H. Chen, Miami, FL (US); Christopher Lauren, Redmond, WA (US)

(72) Inventors: Vijay Aski, Bellevue, WA (US); Danny H. Chen, Miami, FL (US); Christopher Lauren, Redmond, WA (US)

(73) Assignee: Microsoft Corporation, Redmond, WA (US)

(21) Appl. No.: 13/337,140

(22) Filed: Dec. 25, 2011

(51) Int. Cl. G06F 17/30

(52) U.S. Cl. 707/602; 707/E17.005

(57) ABSTRACT

Systems, methods and computer program products that provide a framework for the creation, editing, manipulation and use of model-based, multidimensional analysis services (MAS) cubes are disclosed. A method of generating a model-based MAS cube comprises creating a data source comprising a data warehouse in the memory via the processor, creating a data source view providing a dimension, a fact and an outrigger from the created data source, and creating the MAS cube comprising at least one measure group. A key performance indicator (KPI) may be calculated from the MAS cube as a scorecard of a display associated with the processor. A user of the model-based MAS cube may create a new cube by targeting a set of facts and adding dimensions to the facts.

### CROSS REFERENCE TO RELATED APPLICATION

This Application is related to co-owned, co-pending U.S. patent application Ser. No. 12/129,667 (Attorney Docket No. 324049.01), titled “Model Based Data Warehousing and Analytics,” filed on May 29, 2008, which is hereby incorporated by reference as to its entire contents.

### FIELD OF THE INVENTION

The present invention generally relates to online analytical processing (OLAP) and more particularly to systems, methods and computer program products for facilitating the creation, editing and use of a model-based multidimensional analysis services cube.

### BACKGROUND

In today's technological environment, it is common for knowledge workers and IT professionals to utilize database servers employing the online analytical processing (OLAP) approach to quickly answer multi-dimensional analytical queries. OLAP, part of the broader category of business intelligence, is typically used in business reporting applications for sales, marketing, management reporting, business process management, budgeting and forecasting, financial reporting and the like.

Many database servers and their accompanying database management systems provide developers the ability to create OLAP cubes. An OLAP cube is a data structure that allows fast analysis of data and gives users the capability of manipulating and analyzing data from multiple perspectives. This arrangement of data into cubes overcomes certain limitations of relational databases. More specifically, an OLAP cube is a multi-dimensional representation of data which is pre-aggregated and provides a semantic model. This semantic model enables end users to create reports by connecting to the cube with common desktop applications (e.g., spreadsheet, content management, document management and like applications) to create reports and dashboards by simple drag-and-drop graphical user interface (GUI) actions.

Even though OLAP cubes make creating reports and dashboards easier, most developers do not know how to create them. This is because the process of hand-crafting OLAP cubes can often be painstaking, long and expensive, requiring the services of a professional engineer with in-depth knowledge of data warehousing, dimensional modeling and OLAP concepts. To create OLAP cubes, such a professional engineer must obtain specialized knowledge of the dimensional model specific for the particular system they are working on. Further, even after an OLAP cube is created, efforts must be expended to maintain the cube, which can include creating new partitions for measure groups, adding cube translations for localization purposes, and processing cubes when necessary to ensure that cube data does not become stale.

Given the foregoing, what are needed are systems, methods and computer program products that provide a framework for the creation, editing, manipulation and use of a model-based multidimensional analysis services cube.

### SUMMARY

This summary is provided to introduce a selection of concepts. These concepts are further described below in the Detailed Description. This summary is not intended to identify key features or essential features of the claimed subject matter, nor is this summary intended as an aid in determining the scope of the claimed subject matter.

The present invention meets the above-identified needs by providing systems, methods and computer program products that provide a framework for the creation, editing, manipulation and use of model-based multidimensional analysis services (MAS) cubes.

In an embodiment, the present invention provides systems, methods and computer program products that facilitate the provisioning of a framework to define model-based MAS cubes defined in Extensible Markup Language (XML) files called “management packs,” which are defined by XML schema definitions. The management pack translates the XML to cube objects. In such an embodiment, MAS cubes may be built on top of a model-based data warehouse such as those described in co-owned, co-pending U.S. patent application Ser. No. 12/129,667 (Publ. No. 2009/0299955 A1).

In an embodiment, the framework provided by the systems, methods and computer program products of the present invention facilitate database server users defining new MAS cubes in a manner that eliminates the complexity of defining the cubes manually. In such an embodiment, a user may use a durable framework to declare complex and extensive MAS cube definitions automatically. The use employs a simplistic model to create and then maintain new MAS cubes using as little as three lines of XML in a very declarative fashion by leveraging a model-based data warehouse. The new cubes are maintained automatically to be in synch with data sources when both the schema and the data impact the cubes change in the data sources. As with all management pack content, these MAS cubes can be re-used across different installations by transferring the knowledge packaged in the management pack.

In an embodiment, by leveraging the rich metadata inherent in the simplistic model, such as the relationships between dimensions and facts, MAS cubes can be automatically generated and deployed with minimal involvement from an end user. Conventionally, manually creating MAS cubes can often take developers several weeks to develop, and testers several weeks to test. This is in addition to long-term maintenance costs. Thus, automatically creating MAS cubes based on a management pack model realizes significant costs and time savings.

In various embodiments, the framework provided by the systems, methods and computer program products of the present invention for creating model-based MAS cubes realizes significant benefits over hand-crafted cubes. That is, conventional, hand-crafted OLAP cubes must be custom coded, tested and deployed. They must also be custom managed (i.e., extensible only with additional coding). In contrast, the automatically generated model-based MAS cubes of the present invention may be created with minimal (XML) coding with automatic partitioning and localization.

Further features and advantages of the present invention, as well as the structure and operation of various aspects of the present invention, are described in detail below with reference to the accompanying drawings.

### BRIEF DESCRIPTION OF THE DRAWINGS

The features and advantages of the present invention will become more apparent from the detailed description set forth below when taken in conjunction with the drawings in which like reference numbers indicate identical or functionally similar elements.

FIG. 1 is a block diagram of an exemplary computer system useful for implementing the present invention.

FIG. 2 is an exemplary flow chart diagram illustrating a generation of a data source view (DSV) according to an embodiment of the present invention.

FIG. 3 is an exemplary topology of a system center service manager topology according to an embodiment of the present invention.

FIG. 4 is an exemplary flowchart diagram illustrating the creation of dimensions in an Analysis System Database (ASDB) according to an embodiment of the present invention.

FIG. 5 is an exemplary flowchart diagram illustrating the generation of a cube in ASDB according to an embodiment of the present invention.

FIG. 6 is an exemplary flowchart diagram illustrating the creation of a measure group in ASDB according to an embodiment of the present invention.

FIG. 7 is an exemplary flowchart diagram illustrating the generation of a partition in ASDB according to an embodiment of the present invention.

FIG. 8 is a sample key performance indicator (KPI) for a change request time completion example according to an embodiment of the present invention.

FIG. 9 is a sample KPI for an example “ratio of incidents resolved” according to an embodiment of the present invention.

FIG. 10 is an example of a drillthrough action according to an embodiment of the present invention.

FIG. 11 is an example of a named calculation from a configuration management cube management pack according to an embodiment of the present invention.

FIG. 12 is an example of a custom measure available to a user according to an embodiment of the present invention.

FIG. 13 is an example of a cube extension element according to an embodiment of the present invention.

FIG. 14 is an exemplary portion of a table partition table according to an embodiment of the present invention.

FIG. 15 is an example of a cube partition table according to an embodiment of the present invention.

FIG. 16 is an exemplary flowchart for a comparison of columns of the tables of FIGS. 14 and 15 according to an embodiment of the present invention.

FIG. 17 is an exemplary query for a language for a cube translation from one language to another according to an embodiment of the present invention.

### DETAILED DESCRIPTION

The present invention is directed to systems, methods and computer program products that provide a framework for the automatic creation, editing, manipulation and use of model-based MAS cubes.

In an embodiment, the present invention provides systems, methods and computer program products that facilitate the ability to model an MAS cube in extensible mark-up language (XML) conforming to a simplified model defined in an XML schema definition (XSD). The cube may be automatically deployed to a database management system (e.g., the Microsoft SQL Server® Analysis Services database available from Microsoft Corporation of Redmond, Wash.) with all supporting elements (e.g., data sources, a data warehouse 310, data source views (DSVs), facts, dimensions, outriggers, key performance indicators (KPIs), drill through actions, etc.) as will be defined further below.

In an embodiment, the present invention provides systems, methods and computer program products that facilitate the ability to automatically maintain an MAS cube with no user intervention. Both schema and data of data sources impacting a change to a cube synchronously and automatically update the cube with the change schema and data. This includes partitioning the measure groups within the cube, adding cube translations for localization, and intelligent processing where only the partitions that have stale data are processed so the cube is fully up to date, and grooming of the data.

In an embodiment, the present invention provides systems, methods and computer program products that facilitate the ability to customize a cube after it has been deployed. This includes adding elements such as key performance indicators (KPIs), named calculations, drillthrough actions, custom measures and multidimensional expression (MDX) calculations.

In an embodiment, the present invention provides systems, methods and computer program products that facilitate the ability to carry forward both the MAS cube and any customizations from one environment to another and also from one customer or independent software vendor to several other customers.

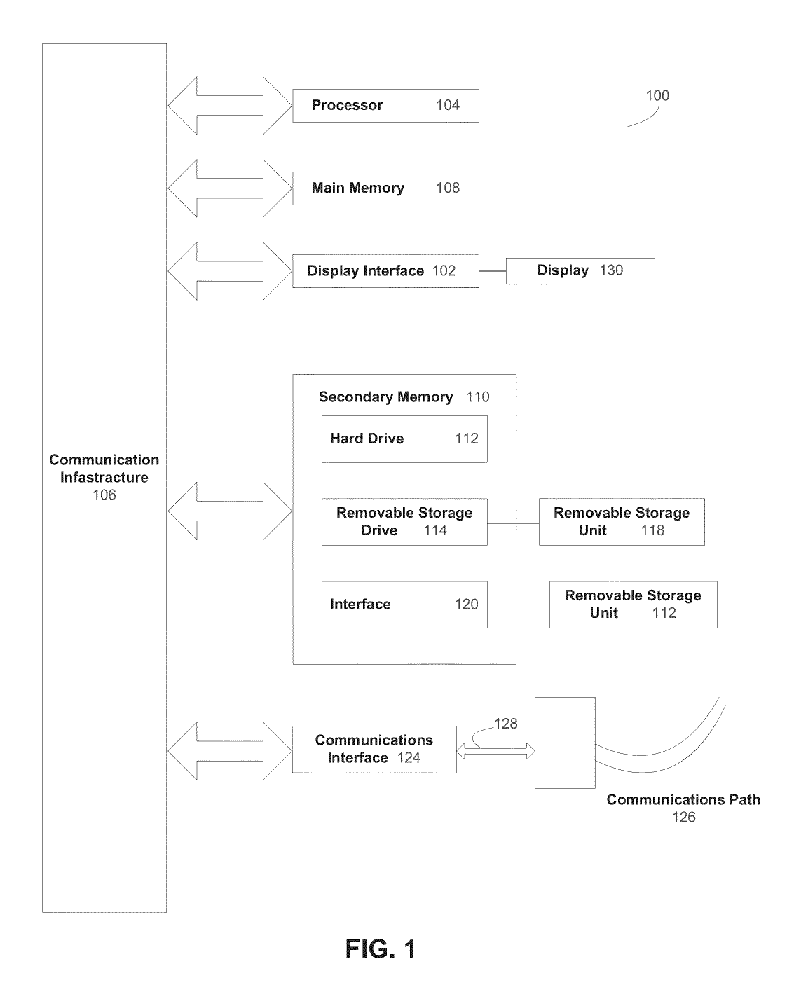

In one embodiment, the invention is directed toward one or more computer systems capable of carrying out the functionality described herein having associated databases. An example of a computer system 100 is shown in FIG. 1.

Computer system 100 includes one or more processors, such as processor 104. The processor 104 is connected to a communication infrastructure 106 (e.g., a communications bus or network). Various software aspects are described in terms of this exemplary computer system. After reading this description, it will become apparent to a person skilled in the relevant art(s) how to implement the invention using other computer systems and/or architectures.

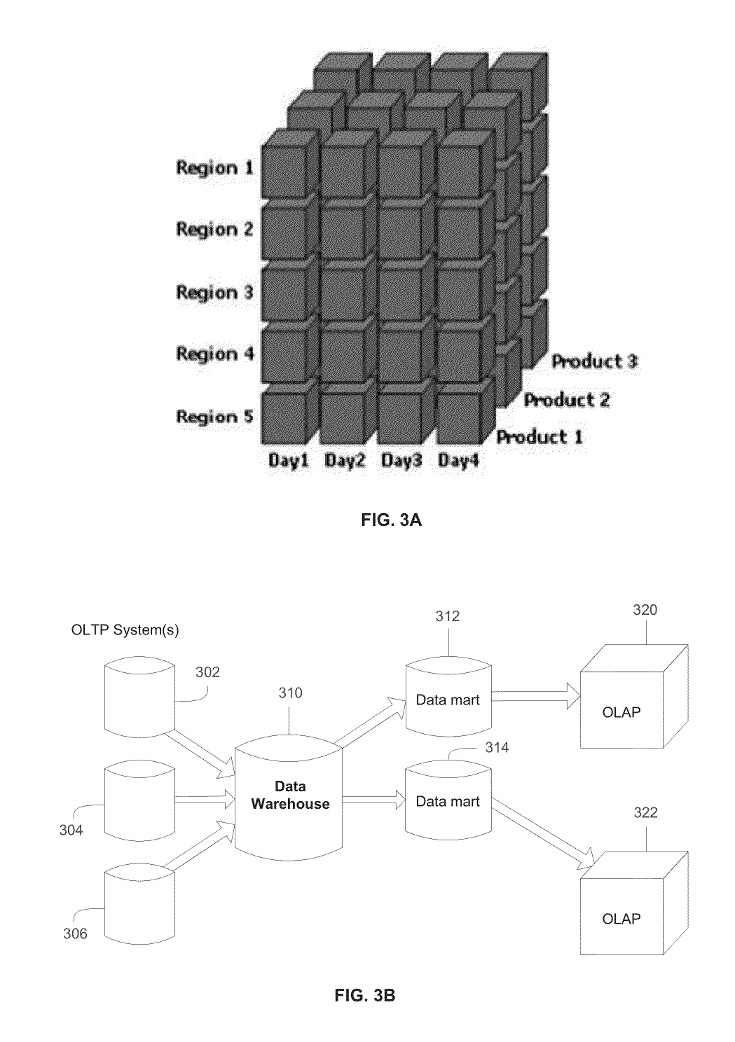

Users at workstations (not shown) communicate with computer system 100 by means of communications interface 106 or other interface known in the art. A typical workstation computer used by a system user may have a similar structure to computer system 100, the difference being that computer system 100 may comprise what is referred to herein as a system manager having one or more of an OLTP system databases 302, 304, 306; data warehouse 310; data marts 312, 314; or associated MAS cubes 320, 322 as per the topology of FIG. 3B. A workstation, on the other hand, provides a user with access to any of these for creating new cubes or doing any of the creation of key performance indicators, drillthrough actions, named calculations, custom measure creation and the like as discussed further herein.

Computer system 100 can include a display interface 102 that forwards graphics, text and other data from the communication infrastructure 106 (or from a frame buffer not shown) for display on the display unit 130. A display, as will be described herein, may provide a dashboard or a scorecard for, for example, key performance indicators or other measures or custom measures.

Computer system 100 also includes a main memory 108, preferably random access memory (RAM) and may also include a secondary memory 110. The secondary memory 110 may include, for example, a hard disk drive 112 and/or a removable storage drive 114, representing a floppy disk drive, a magnetic tape drive, an optical disk drive, etc. The removable storage drive 114 reads from and/or writes to a removable storage unit 118 in a well known manner. Removable storage unit 118 represents a floppy disk, magnetic tape, optical disk, etc. which is read by and written to by removable storage drive 114. As will be appreciated, the removable storage unit 118 includes a computer usable storage medium having stored therein computer software and/or data.

In alternative aspects, secondary memory 110 may include other similar devices for allowing computer programs or other code or instructions to be loaded into computer system 100. Such devices may include, for example, a removable storage unit 122 and an interface 120. Examples of such may include a program cartridge and cartridge interface (such as that found in video game devices), a removable memory chip (such as an erasable programmable read only memory (EPROM), or programmable read only memory (PROM)) and associated socket and other removable storage units 122 and interfaces 120, which allow software and data to be transferred from the removable storage unit 122 to computer system 100.

Computer system 100 may also include a communications interface 124. Communications interface 124 allows software and data to be transferred between computer system 100 and external devices. Examples of communications interface 124 may include a modem, a network interface (such as an Ethernet card), a communications port, a Personal Computer Memory Card International Association (PCMCIA) slot and card, etc. Software and data transferred via communications interface 124 are in the form of non-transitory signals 128 which may be electronic, electromagnetic, optical or other signals capable of being received by communications interface 124. These signals 128 are provided to communications interface 124 via a communications path (e.g., channel) 126. This channel 126 carries signals 128 and may be implemented using wire or cable, fiber optics, a telephone line, a cellular link, an radio frequency (RF) link and other communications channels.

In this document, the terms “computer program medium” and “computer usable medium” are used to generally refer to media such as removable storage drive 114, a hard disk installed in hard disk drive 112 and signals 128. These computer program products provide software to computer system 100. The invention is directed to such computer program products.

Computer programs (also referred to as computer control logic) are stored in main memory 108 and/or secondary memory 110. Computer programs may also be received via communications interface 124. Such computer programs, when executed, enable the computer system 100 to perform the features of the present invention, as discussed herein. In particular, the computer programs, when executed, enable the processor 104 to perform the features of the present invention. Accordingly, such computer programs represent controllers of the computer system 100.

In an embodiment where the invention is implemented using software, the software may be stored in a computer program product and loaded into computer system 100 using removable storage drive 114, hard drive 112 or communications interface 124. The control logic (software), when executed by the processor 104, causes the processor 104 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

As will be apparent to one skilled in the relevant art(s) after reading the description herein, the computer architecture shown in FIG. 1 may be configured as any number of computing devices such as a system manager, a work station, a game console, a portable media player, a desktop, a laptop, a server, a tablet computer, a PDA, a mobile computer, a smart telephone, a mobile telephone, an intelligent communications device or the like.

In yet another embodiment, the invention is implemented using a combination of both hardware and software.

Now, an environment will be described wherein a computer-implemented method of creating and utilizing a model-based MAS cube will be briefly described and terms defined as used in the specification and claims. Such an exemplary environment may include a data warehouse 310 consisting of one or a plurality of data sources among other entities (not shown). The various entities such as data sources and one or more data warehouses 310 may be located relatively close together or distributed around the world and connected together by one or more networks including inter- and intra-office networks. A given data warehouse 310 may include a data source or store capable of storing data in a structured format and comprise any storage media capable of storing data.

Data stored in a data warehouse 310 may be organized in tables, records, objects, other data structures and the like. Data warehouse 310 may comprise a relational database, an object-oriented database, a hierarchical database, any other known type of database, or any combination of these. An exemplary data warehouse 310 involves associating schema including a fact, typically a plurality of dimensions and outriggers. A fact is something known as having demonstrable existence or is objectively real. Examples of facts may be, in a business sense, the existence of a purchase order having a given date, a quantity of described goods or services and the like. Other examples of facts may readily come to mind. A fact associates dimensions. A fact may be used to create a fact table with rows associating corresponding rows of dimension tables. As an example, a row of a fact table may include keys of a salesperson, a store, a customer and a product or a service.

An outrigger associates properties of one or more types associated with dimensions. For example, one type may include computer information where computers may be manufactured by different manufacturers. Another type may be printer information. Instead of storing manufacturers of computers in dimension tables, a manufacturer identifier may be stored in a dimension table. The manufacturer identifier may be stored in an outrigger table and, as a tuple, stored with the manufacturer name.

An Online Analytical Processing (OLAP) cube 320, 322 is a data structure that overcomes limitations of relational and other types of databases by providing rapid analysis of data. Cubes can display and sum up large amounts of data of associated data marts 312, 314 while also providing users queryable access to the most granular of data so it can be rolled up, sliced, and diced as needed to handle the widest variety of questions germane to a user's domain of interest.

As discussed further herein, once OLAP cubes 320, 322 have been built and populated in an analysis services system, users of tools such as Business Intelligence Development Studio (BIDS), Microsoft Excel® spreadsheets, Analysis Service's Cube Browser (available from Microsoft Corporation of Redmond, Wash.) and the like can query and view the cube data. In an embodiment of the present invention, an Analysis Management Objects (AMO) application programming interface (API) is provided with a server product (e.g., System Center Service Manager 2012 (“SCSM 2012”), available from Microsoft Corporation of Redmond, Wash.) to create the cubes. This API programmatically translates elements defined in XML to its counterpart class in the AMO API. The AMO API computationally and automatically implements changes to the cubes, metadata and the model serving as a framework for building or changing cubes.

In such an embodiment, there are four elements defined above: data sources, Data Source View, dimensions and MAS cubes. Each is discussed below (including an associated flow chart illustrating its creation).

### Data Sources

Data Sources, as defined above, are created on setup, along with user roles which are configured to have the appropriate access to the data source and analysis system databases (ASDB's). The data source may be considered an existing data mart 312, 314 or data store with facts and dimensions, as defined above, from the SCSM data warehouse 310.

### Data Source View

The Data Source View (DSV) is a collection of views representing the dimensions, facts, and outriggers from the data source. The DSV will contain all primary and foreign key relationships between tables. When interpreting a Management Pack created MAS Cube 320, 322, a model automatically determines all primary keys (PK) and foreign keys (FK) for the end user “under the hood.” For example, a user will always know which dimensions are targeted by a fact, which frees the user from having to provide that information or even be aware of it. The DSV provides a layer of abstraction on top of a relational or other database. The data source view is automatically generated and updated when each management pack is processed and its contents are deployed and mapped onto the Analysis Services (AS) database. The management pack translates extensible markup language to cube objects.

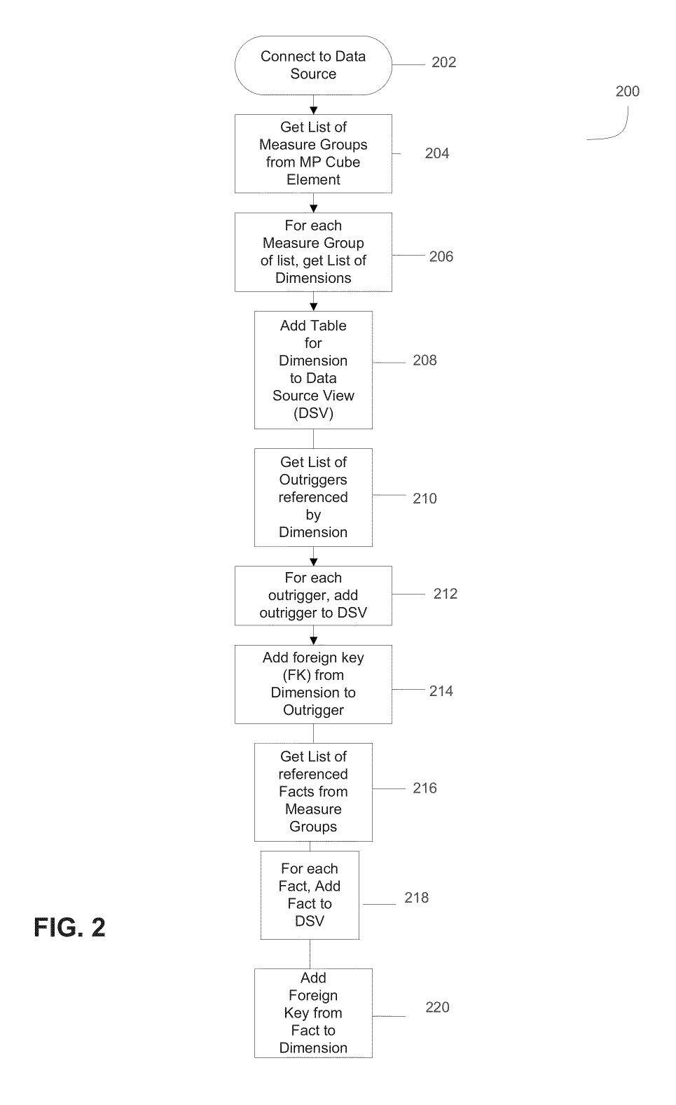

Referring to FIG. 2, a flowchart is shown illustrating a Data Source View generation process 200, according to an embodiment of the present invention. Using a server product such as SCSM 2012, process 200 begins at step 202 where a user connects to a data source. Referring briefly to FIG. 3B, data sources are pervasive in an enterprise and are utilized for creation and updating data warehouse 310. The user then obtains from their workstation a list of measure groups from a Management Pack Cube element 204. A measure group, by way of example, is a data element group having a measurable parameter such as date or price. At step 206, the user gets a list of dimensions as defined above for each measure group of the obtained list. At step 208, the user adds a table for the obtained dimension to a Data Source View as the View is created. At step 210, the user gets a list of outriggers referenced by the obtained dimensions as defined above. At step 212, for each outrigger, the user may add an outrigger to the Data Source View. At step 214, the user adds a foreign key (FK) from the obtained dimension to the outrigger. At step 216, the user obtains a list of referenced facts, as defined above, from the measure groups. At step 218, for each obtained fact, the user adds the fact to the Data Source View. Then, at step 220, the user adds the foreign key from the fact to the dimension completing the Data Source View.

### Dimension

Each dimension in the ASDB references a dimension or outrigger from data warehouse 310. A dimension is roughly analogous to a management pack class and has a list of attributes which can be used to filter and group data in the MAS cube. A class is illustrated in FIG. 3A for a cube that contains, by way of example, Date, Region, and Product Dimensions. These are merely exemplary and more or fewer and different dimensions may be appropriate for a data cube class.

Referring to FIG. 3B, a topology of a server product (such as SCSM 2012) is shown comprising a data warehouse (DW) 310 with MAS cubes 320, 322. MAS cubes 320, 322 can be considered a final piece of a puzzle for a data warehousing solution. In an embodiment, online transaction processing (OLTP) systems 302, 304 and 306—via user workstations—access DW 310 for development of data marts 312 and 314 of associated MAS cubes 320, 322.

Each dimension is also automatically created during the deployment of the management pack to the ASDB. Because DW 310 is to be model-based, a user can automatically determine without any user input all the attributes of the dimension in the DW 310 and create a corresponding dimension in the ASDB. As one can see in the cube model, there actually is no element to define the dimensions for a cube. That is because which dimensions to include for a cube based on the facts that the cube is targeting via the included measure groups can automatically be derived. The burden is lifted off the end user to retain this specific knowledge. An advanced user, however, may be able to define “role playing dimensions” in a cube that derive from the main AS Dimension. The substitution element in the management pack (MP) allows users to define these role playing dimensions as well as substitute a new dimension for an original dimension targeted by a fact if allowed. In any multi-dimensional model, the same database dimension may play multiple roles. For example, a time dimension (FIG. 3A) can be used twice for a measure group containing flight data. One would be named “Departure Time” and the other would be “Arrival Time” on the same or different days depending on the length of the flight. Although based on the same dimension, they play and describe different roles for that measure group and can be used to filter accordingly.

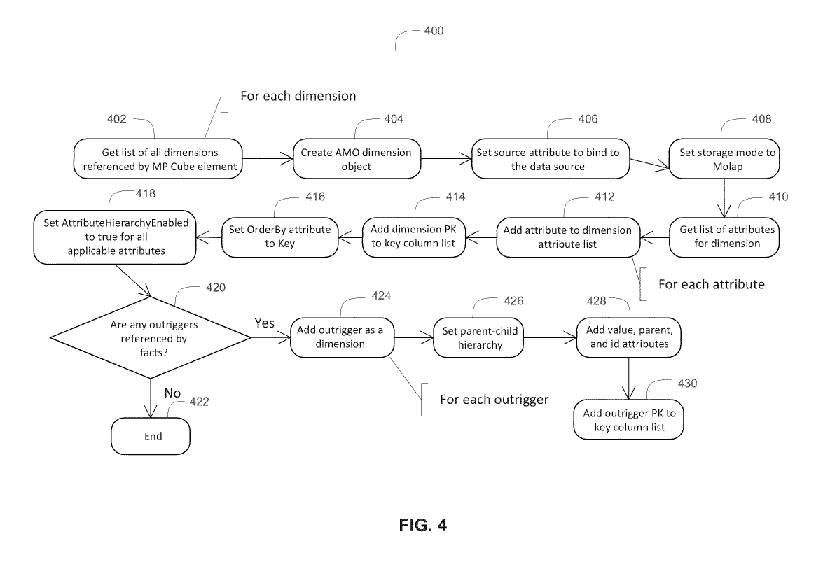

Referring now to FIG. 4, a flow chart is shown illustrating a dimensions creation process 400 by a user in an analysis system database (ASDB), according to an embodiment of the present invention. At step 402, a user gets a list of all dimensions referenced by a management pack (MP) cube element for each dimension. At step 404, the user creates an analysis management object (AMO) dimension object. At step 406, the user sets a source attribute to bind to the data source. At step 408, the user sets a storage mode to M OLAP. At 410, the user retrieves a list of attributes for a dimension. At 412, the user adds the attribute to a dimension attribute list. At step 414, the user adds a dimension primary key (PK) to a key column list. At step 416, the user sets an OrderBy attribute to the key. At step 418, the user sets AttributeHierarchyEnabled to be true for all applicable attributes. At step 422, the user may determine whether there are any outriggers referenced by facts. If the answer is “no,” at step 422, the user is done. However, if the answer is “yes,” at step 424, the outrigger referenced by a fact is added as a dimension for each such outrigger. At step 426, the user sets a parent-child hierarchy. At step 428, the user adds a value, and identifies a parent and identification attributes. At step 430, the user adds the outrigger primary key to the key column list (similarly as at step 414) and the user is done.

### Cube

A cube is the main data structure for the analysis system database (ASDB) that contains the aggregated data. The cube is browsable by the end user. Every cube contains a collection of measure groups. In the management pack, the user defines each of the measure groups they want to include in the cube. Each measure group, for example, maps to a specific fact in DW 310. When creating the measure group in the ASDB, a user includes a count of members of the measure group as a default measure for that measure group. Additional measures may be added. For example, each of the custom facts in a server product such as SCSM 2012 may define at least one or more measures, and these measures will automatically be added to the measure group in the Cube.

Each measure group also contains a list of partitions, which hold the actual data in separate non-overlapping sections. A DW maintenance background workflow will automatically manage partitions for the cube to match up with the fact partitions defined in the data mart 312, 314.

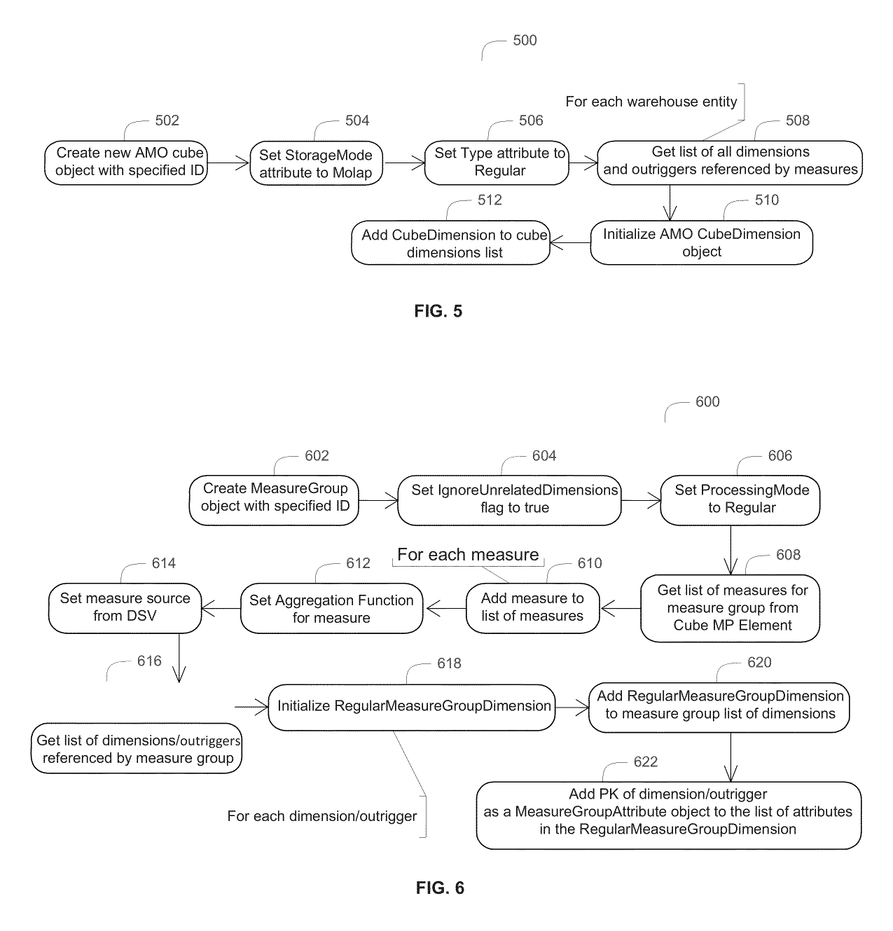

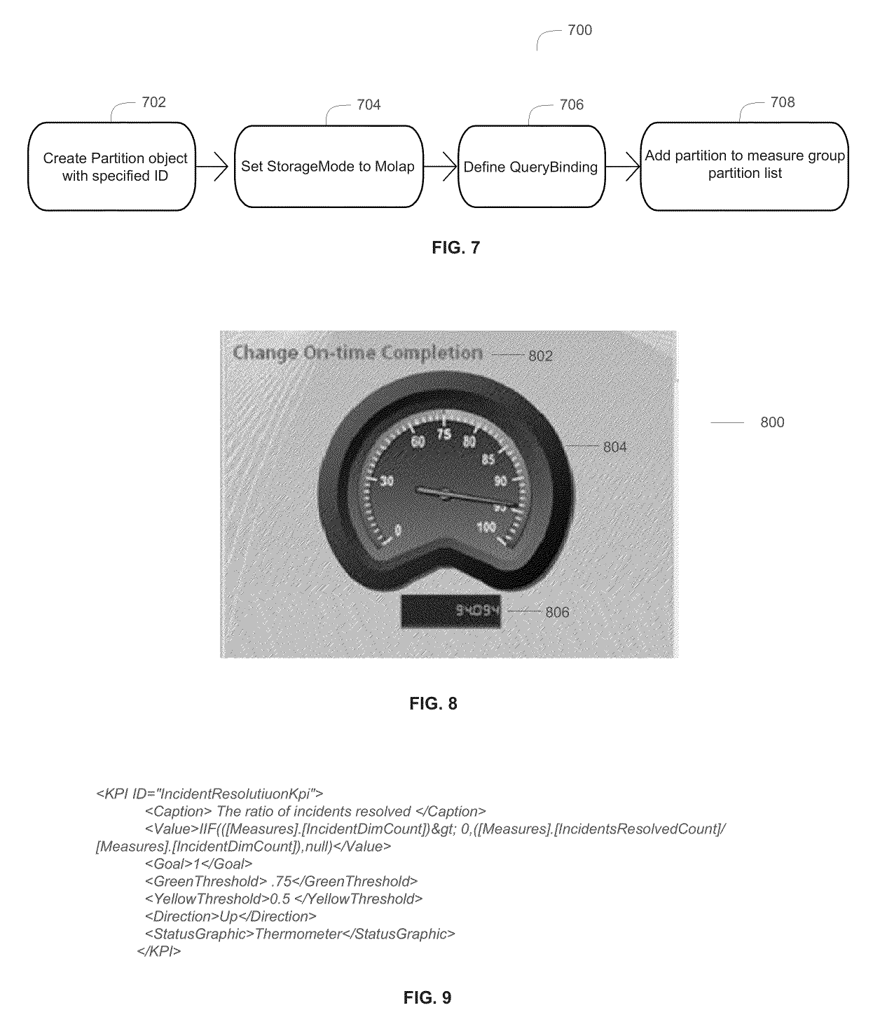

Referring to FIGS. 5-7, there are provided flowcharts illustrating a description of how cubes and associated measure groups and partitions may be created by users in ASDB. There is shown in FIG. 5 a flowchart 500 for cube generation in ASDB. FIG. 6 is an exemplary flowchart 600 for generating measure groups in ASDB. FIG. 7 is an exemplary flowchart 700 for generating partitions in ASDB.

In FIG. 5, at step 502, a user creates a new AMO cube object with a specified identifier (ID). At step 504, the user may set a StorageMode attribute to M OLAP. At step 506, a user sets a Type attribute to Regular. At step 508, the user gets a list of all dimensions and outriggers referenced by measures. At step 510, the user may initialize an analysis management object (AMO) CubeDimension object. At step 512, the user adds CubeDimension to a cube dimension list. In this exemplary manner, the user may generate a cube.

In FIG. 6, at step 602, a user begins an exemplary process of generating a measure group by creating a MeasureGroup object with a specified identifier (ID). At step 604, the user may set an IgnoreUnrelatedDimensions flag to True. At step 606, the user sets a Processing Mode to Regular. At step 608, the user gets a list of measures for a measure group from a Cube management pack (MP) element. At step 610, for each measure of the list, the user adds the measure to a list of measures. At step 612, the user sets an Aggregation function for a given measure. At step 614, the user sets a measure source from a data source view (DSV). At step 616, the user obtains a list of dimensions and outriggers referenced by the measure group. At step 618, for each dimension/outrigger, the user may initialize a RegularMeasureGroupDimension. At step 620, the user may add RegularMeasureGroupDimension to an associated measure group list of dimensions. At step 622, the user may add a primary key (PK) of a dimension/outrigger as a MeasureGroupAttribute object to the list of attributes in the RegularMeasureGroupDimension.

In FIG. 7, at step 702, a user creates a partition object having a specified identifier (ID). At step 704, the user sets StorageMode to M OLAP. At step 706, the user may define QueryBinding. Then, at step 708, the user may add the partition to a measure group partition list.

In addition to measure groups, cubes can also contain the following five elements:

(1) Key Performance Indicators (KPIs): KPIs are business metrics that can be defined to monitor progress towards certain objectives and goals. A KPI will usually have a target and an actual value, which will represent a quantitative goal that is critical to the success of an organization. KPIs are usually displayed on a scorecard, which may contain a group of KPIs, to show the overall health of the business in one quick snapshot. Many different snapshots are possible and selectable from which a dashboard may be generated containing representations of a plurality of KPIs.

An example of a KPI is to complete all change requests within 48 hours. A KPI can be used to measure what percentage of change requests are resolved within that time frame. An SM Dashboard may represent the KPI visually. Referring to FIG. 8, an example dashboard is shown for a change request on-time completion 802 metric. The KPI target value for completion of all change requests within 48 hours is 75%. The actual value as shown by the dial may be 94% and indicated to a specified number of decimal points at 806.

A sample KPI element is shown in FIG. 9, illustrating the ratio of incidents resolved and thresholds such as 75% for green, 50% for yellow and the like. These KPIs can be defined either in the <SystemCenterCube> or <CubeExtension> element. When the management pack (MP) is deployed, the KPI will be created in AMO and added to the collection of KPIs in the AMO cube object.

(2) Drillthrough Actions: When users “drill through” data, they may want to see all the individual transactions that contributed to the cube's aggregated data. In other words, the user can retrieve the data at a lowest level of granularity for a given measure value. For example, when given the sales data for a particular month and product category, a user may “drillthrough” that data to see a list of each table row that is contained within that cell of data.

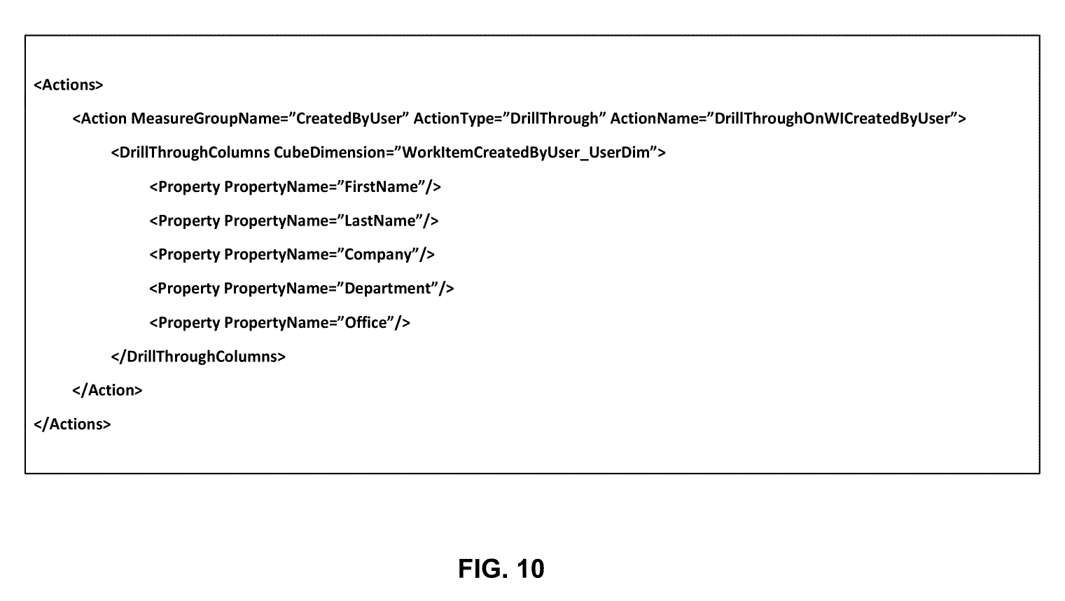

An example of a drillthrough action is provided in FIG. 10 wherein <Actions> defines an example drillthrough action, drilling through first and last names, company, department and office, by way of example, to obtain a work item.

As with other management pack elements, a user may translate this to an AMO DrillThroughAction object during the deployment of the management pack and attach it to the AMO cube's collection of actions. The changes are then persisted to the ASDB via an Update( ) call to the cube object. As above, actions may be defined in both the <SystemCenterCube> and <CubeExtension> elements.

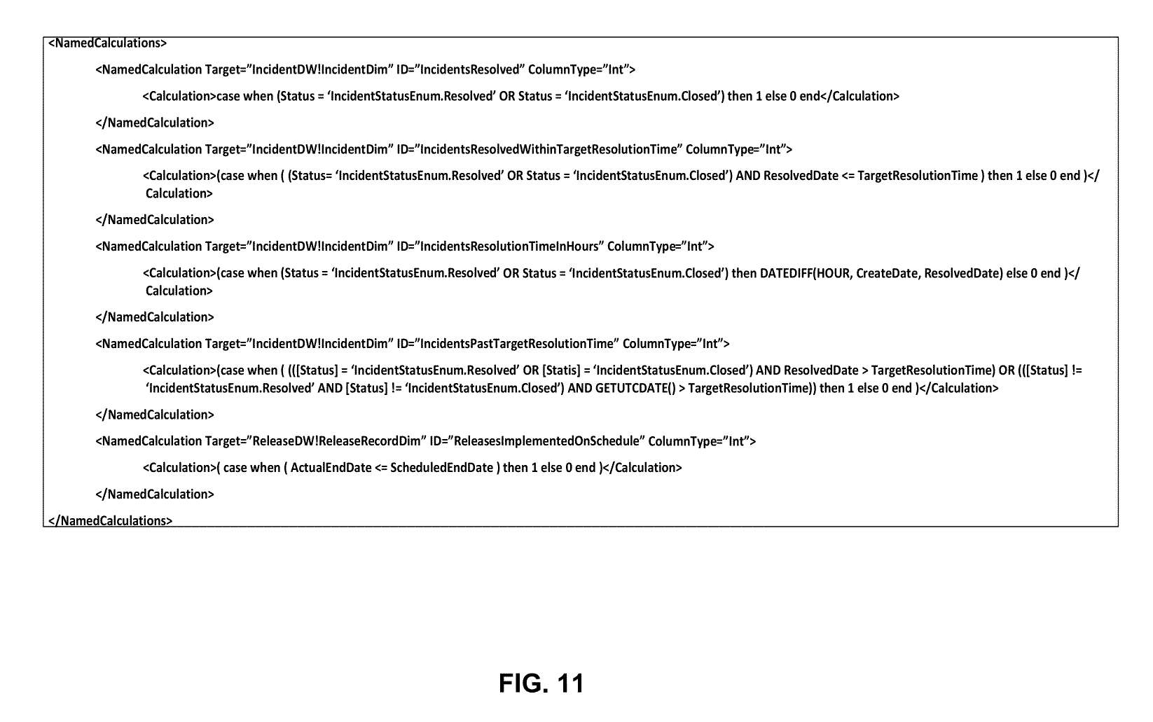

(3) Named Calculations: Named calculations enable a user to define calculated attributes on a dimension that did not previously exist. This allows the user to enable a wide range of business intelligence (BI) scenarios and extract relevant trends from the data that otherwise would not be able to be calculated. An example from the ConfigurationManagement Cubes MP is illustrated in FIG. 11. For example, the Target may be incident data warehouse, incident dimension where an identifier is Incidents Resolved and a column type is Int.

These named calculations may be applied to the DSV when the management pack is deployed. Custom measures can then be targeted at these named calculations to surface the calculated data to the end user for analysis. As above, named calculations may be defined in both the <SystemCenterCube> and <CubeExtension> elements.

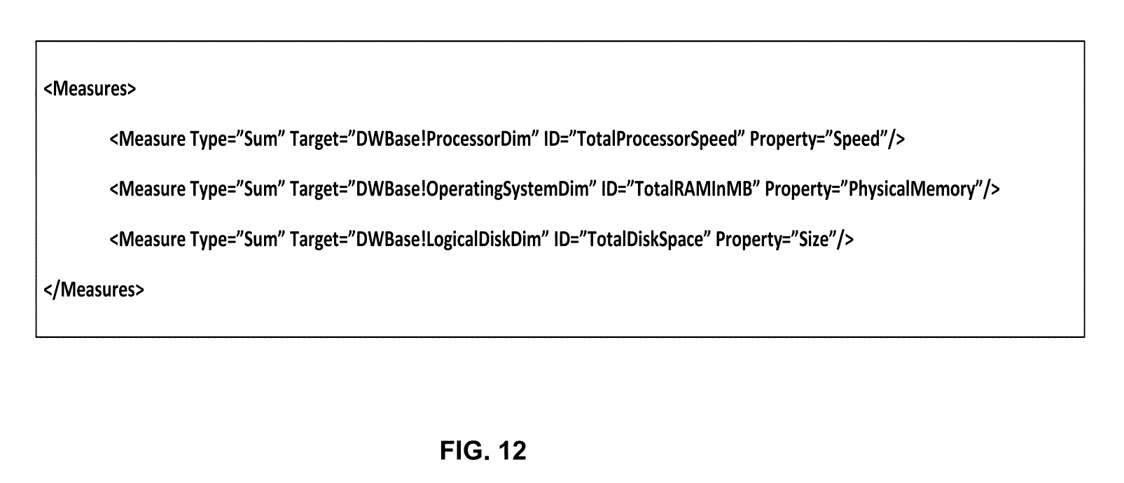

(4) Custom Measures: In addition to the measures a user automatically adds to measure groups when creating a cube, a user has the ability to add their own measures to any measure group. The measure can be a sum or count based on any numeric attribute in any of the dimensions in the cube. An example from the ConfigurationManagementCubes management pack is illustrated in FIG. 12, where custom measures are defined as <measures>, for example, a data warehouse processor total processor speed measure. When translating these elements from XML to the cube, a user may find the associated measure group for each target and create an additional measure in AMO and commit the changes for that measure group. An update( ) method is then called on the cube to commit the changes to the ASDB. Custom measures can target attributes on any existing dimension or a user-defined Named Calculations described above. These elements can be defined in both the <SystemCenterCube> and <CubeExtension> elements.

(5) Custom MDX: The management pack MAS framework provides bundling of a resource containing MDXScripts content to an MAS cube and automatic application to the cube during creation. A user may add MDXScripts from the bundled resource allowing the user to define any number of MDX statements on the cube. The full power and capabilities of MDX are available to the end user to apply to the cube in this scenario. Users attach an MDX Script to the Management Pack (MP) and bundle everything together into a Management Pack Bundle (MPB). During the deployment of the cube, the code will access the attached MDX Script and add it to the AMO cube's collection of MDXScripts.

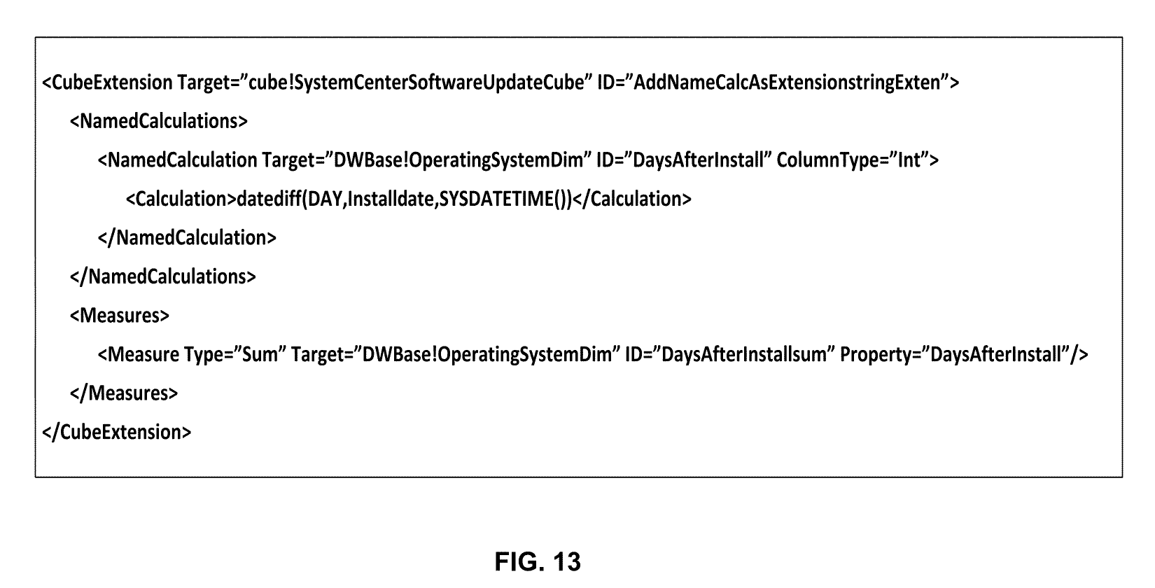

A further element alluded to above and now described is a <CubeExtension> element. This element allows the user to extend a cube after it has already been deployed to the ASDB. A sample cube extension is shown in FIG. 13. A user by way of example defines CubeExtension Target via <NamedCalculations> and <Measures> as described above. In particular, a “named calculations” and a “custom measure” are added to the cube “SystemCenterSoftwareUpdateCube.” This allows a user the flexibility to extend a cube after it has already been defined instead of having to rebuild the cube from scratch. Also, this process is automated and does not require any extra code and manual customization performed by an engineer unlike in a scenario where cubes are hand-crafted.

### Automatic Maintenance of Cubes

In hand-crafted cubes, the cube owner/administrator is responsible for creating partitions, adding translations (for localizability purposes), and processing the cube. In an embodiment, a server product (such as SCSM 2012) may perform these operations automatically for the user via a workflow job that runs in the background by a user-configurable scheduled data warehouse maintenance module.

Partition Management: In conventional server products, the data mart 312, 314 has a table such as an “etl.TablePartition” table which contains for each fact all the partitions created. New partitions are created for each fact, for example, at most once a month for the upcoming month. In a server product implementing the present invention, this table is leveraged to generate a 1:1 mapping between each fact partition in the data mart and each measure group partition that targets that particular fact. When the DW Maintenance job runs, each of the partitions of the measure group are automatically compared to the fact partitions and maintained according to a regularly scheduled job running in the background to maintain the cube. Any partitions that are missing in the measure group partitions are automatically added. If the measure group contains a partition that is no longer in the fact partition collection, then the partition is automatically deleted. The appropriate entries are then added to the etl.CubePartition tables which are also used to perform intelligent processing of cubes as now described.

Intelligent Processing: In hand-crafted cubes, it is very difficult for a systems administrator to determine the partitions of each measure group which need to be updated as data flows into the source data mart. Because of this, the default action is to perform a “process full” on the cube, which requires deleting existing partition data, indexes, and aggregations and rebuilding them from scratch. This can be a very expensive operation.

In a server product implementing the present invention, partitions are tracked that have been modified since the last load job via the user of watermarks. Thus, when a cube is processed, a user knows which partitions to reprocess and which partitions may be left alone. Also, the user can perform ProcessAdd actions on partitions where data was only added and not updated. The ProcessAdd operation will incrementally update a partition and the existing indexes and aggregations are left intact. This is a less expensive operation than a ProcessFull. For each partition where data was updated, a ProcessFull is performed only on that particular partition rather than on the MAS cube as a whole.

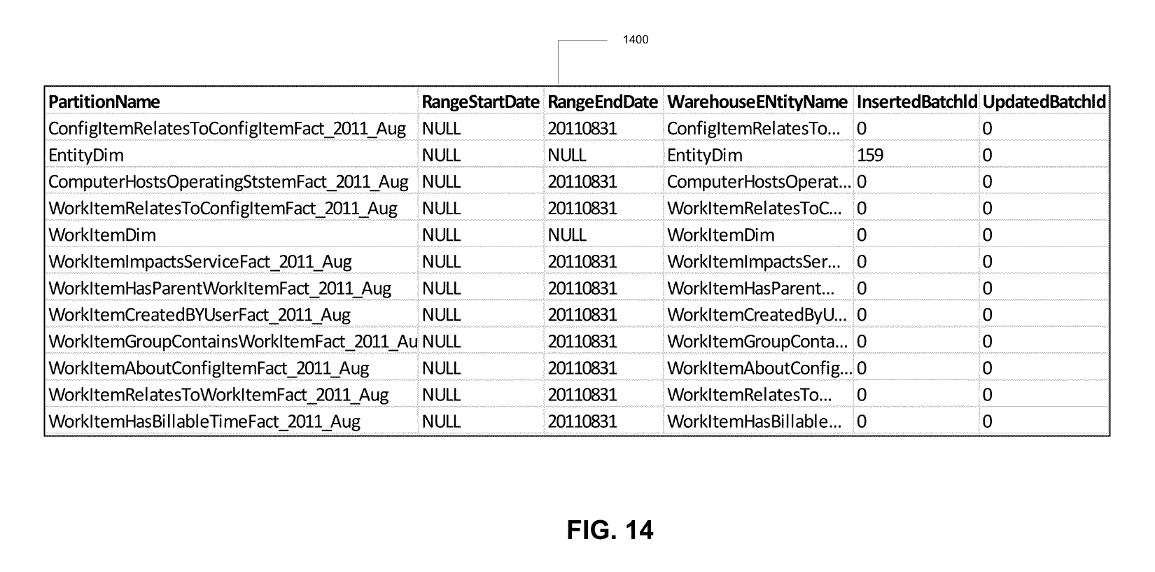

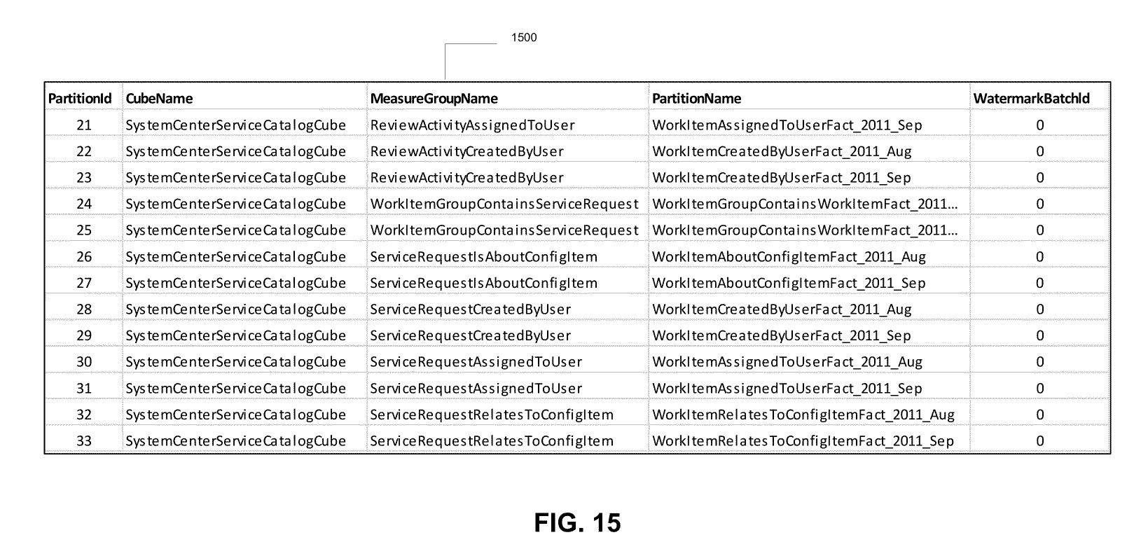

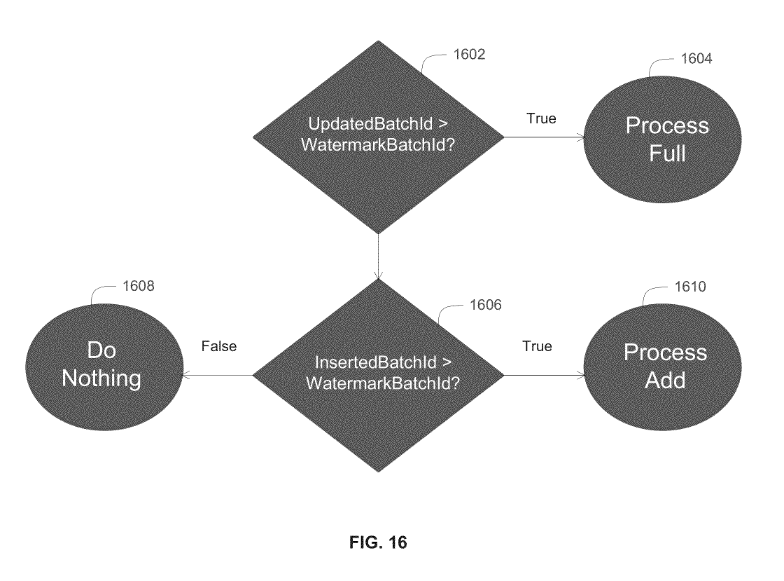

To accomplish this, the load job will update in the etl.TablePartition table in the data mart with the batch number of the most recent job that added or modified data in the partition. FIG. 14 shows a snapshot of an exemplary table. Note that InsertedBatchld and UpdatedBatchld columns are shown. The etl.CubePartition table in the data mart contains for each measure group partition, the batchId of the load job that the data was processed for FIG. 15 shows a snapshot of the table. The WatermarkBatchId from the CubePartition table is compared to the Inserted/UpdatedBatchld from the TablePartition Table. The processing action that results depends on the result of this comparison and is illustrated in FIG. 16 which provides a flowchart for the process.

Cube Translations: Cube Translations are also handled by the DW Maintenance job. When the DW Maintenance job runs, translations are only added to the cube when the DisplayString dimension contains new data brought over by the load job in the ETL process. When this happens, a flag is set which activates the translation step on the next run of the DW maintenance job.

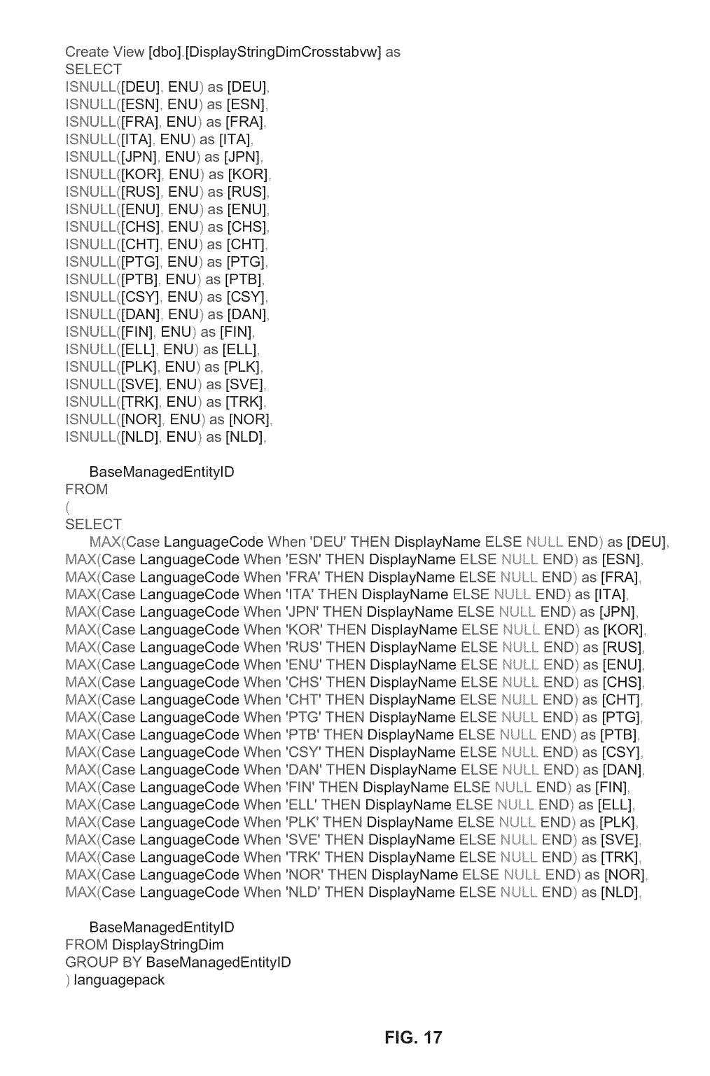

In an embodiment, during the execution of the cube translation step, translations are added to support multiple languages that are officially supported by the server product. If translations exist for a particular language, the default English value is added. A user determines the translations by querying against the DisplayStringDim which contains all the localized values for any element in the product if it exists. Translations are added to the cubes responsive to the display strings in different languages in a management pack based on the model. Automatic translations may be considered a part of automatic cube maintenance. To reduce the number of calls to the DB, a user may return all the translated values for each language per element via a DisplayStringDimCrossTabView. The query for that view is shown in FIG. 17 for supported languages.

### Automatic Mode of Creating Cubes

An automatic mode is provided to a user for creating cubes in just a few lines of code. A user may be unsophisticated and does not need to know sequential query language (SQL). All the SQL, including joins, and any added or calculated properties may be done automatically. The auto mode will enable even novice users with little knowledge about cubes to leverage all the benefits the cubes provide. In the auto mode, cube elements such as measures, measure groups, and aggregations are automatically generated and defined with no additional input from the user. Moreover, a finer grain of control is also available in the automatic mode.

In the Auto mode, all the user needs to do is define a cube that target a set of facts. All the supporting elements will be automatically constructed behind the scenes to create the cube. Two examples will now be discussed.

### EXAMPLE 1

Below is a XML example of a ManagementPackCubeElement in the Auto mode in which the cube is targeted at two relationship facts—operating system and network adapter:

```
<Cube ID=“ComputerCube” Accessibility=“Public” Mode=“Auto” >
  <Facts>
      <Fact ID=“ComputerHostsOperatingSystem” />
      <Fact ID=“ComputerHostsNetworkAdapter” />
  </Facts>
</Cube>
```

From this ManagementPackCubeElement, deployment can determine all the dimensions that need to be added to the cube by iterating through each fact, and identifying the source and target dimensions. These dimensions will be added to both the datasource view and the cube. In addition to these dimensions, the date dimension will by default be added to the cube as well so the user can specify date ranges to slice and dice the data and also be able to drill down on the date hierarchy (Year→Quarter→Month→Week→Day).

Each fact listed in the cube will result in a measure group which will contain one measure which is the count for that fact. The Measure Groups will be as follows:

| | | Aggrega- |
|---|---|---|
| MeasureGroup Name | Measure Name | tion Type |
| ComputerHostsOper- | ComputerHostsOper- | Count |
| atingSystemGroup | atingSystemCount | |
| ComputerHostsNet- | ComputerHostsNet- | Count |
| workAdapterGroup | workAdapterCount | |

In addition to these two measure groups, one may also have one measure group to measure the counts for all the dimensions for the associated facts as follows:

| | | Aggrega- |
|---|---|---|
| MeasureGroup Name | Measure Name | tion Type |
| ComputerCubeDimensionGroup | ComputerDimCount | Count |
| | OperatingSystemDimCount | Count |
| | NetworkAdapterDimCount | Count |

In auto mode, a user may also create a cube for a fact with measures thus providing a finer grain of control.

### EXAMPLE 2

In the following cube identification, a cube may be ActivityStatusDurationCube where the duration may be the fact having a measure in time:

```
<Cube ID=“ActivityStatusDurationCube” Accessibility=“Public”
Mode=“Auto” >
    <Facts>
  <Fact ID=“ActivityStatusDurationFact” />
  </Facts>
</Cube>
```

When determining which dimensions to add to a cube for this fact, a user may have to consider how to process the ActivityStatus outrigger. Since a user would want to filter on the values of ActivityStatus, a user may surface outriggers that are part of the fact as dimensions in both the DataSourceView and the cube. Thus, for ActivityStatusDurationFact, two dimensions will be added: (1) ActivityDim; and (2) ActivityStatusDim.

Similar to the previous example, a measure group will be generated for this fact. Because this is an actual fact with a measure and not a relationship fact, the measure name will be the actual measure from the fact.

| | | Aggrega- |
|---|---|---|
| MeasureGroup Name | Measure Name | tion Type |
| ActivityStatusDur- | ActivityTotalTimeMeasure | Sum |
| ationFactGroup | | |

The measure group for the fact in auto mode will automatically surface the aggregation function of the measure as a sum because the majority of measures in facts are computed as sums. Note that if this is not the case, the user can define another aggregation function type in manual mode. A user may also not include a count of the instance for a non-relationship fact.

One measure group may measure the counts for all dimensions that are associated. Note that although the ActivityStatus outrigger is surfaced as a dimension in the DataSourceView, a user may not include the ActivityStatus count as a measure in the example measure group.

| | | Aggrega- |
|---|---|---|
| MeasureGroup Name | Measure Name | tion Type |
| ActivityDimGroup | ActivityDimCount | Count |

Finally, in Auto Mode, all partitions of measure groups by default may be by month or other default element of time.

While various aspects of the present invention have been described above, it should be understood that they have been presented by way of example and not limitation. It will be apparent to persons skilled in the relevant art(s) that various changes in form and detail can be made therein without departing from the spirit and scope of the present invention. Thus, the present invention should not be limited by any of the above described exemplary aspects, but should be defined only in accordance with the following claims and their equivalents.

In addition, it should be understood that the figures in the attachments, which highlight the structure, methodology, functionality and advantages of the present invention, are presented for example purposes only. The present invention is sufficiently flexible and configurable, such that it may be implemented in ways other than that shown in the accompanying figures.

Further, the purpose of the foregoing Abstract is to enable the U.S. Patent and Trademark Office and the public generally and especially the scientists, engineers and practitioners in the relevant art(s) who are not familiar with patent or legal terms or phraseology, to determine quickly from a cursory inspection the nature and essence of this technical disclosure. The Abstract is not intended to be limiting as to the scope of the present invention in any way.

What is claimed is:

1. A computer-implemented framework comprising a programmed processor and memory, the processor declaring a complex definition of an multidimensional analysis services cube, the framework comprising a model stored in processor memory whereby the multidimensional analysis services cube is created and maintained automatically and synchronously when extensible markup language schema and data of a data source change, thereby impacting the multidimensional analysis services cube.

2. The computer-implemented framework of claim 1 comprising a method of generating the model-based multidimensional analysis services cube in extensible markup language using the processor, the memory and a display, the method comprising the steps of:
(a) creating a data source comprising a data warehouse in the memory via the processor;
(b) creating a data source view providing a dimension, a fact and an outrigger from the created data source;
(c) automatically creating the multidimensional analysis services cube comprising at least one measure group responsive to a change in data of the data source; and
(d) displaying a value of a key performance indicator calculated from the multidimensional analysis services cube as a scorecard on the display.

3. The computer-implemented framework of claim 2, further comprising the step of:
(e) retrieving data at first, second and third levels of granularity for a given measured value as a drillthrough action by the processor.

4. The computer-implemented framework of claim 2, wherein the memory contains a data mart associated with the online analytical cube, further comprising the steps of:
(e) comparing each fact partition of the data mart to a partition of a measure group,
(f) adding a missing partition to the measure group, and
(g) deleting a partition from the measure group when the measure group no longer contains an associated fact partition, the partitions being automatically maintained by repeated comparing, adding and deleting.

5. The computer-implemented framework of claim 2, further comprising the step of:
(e) marking partitions modified during updating of the online analytical cube by maintaining a batch number in memory for added or updated data.

6. The computer-implemented framework of claim 4, further comprising the step of:
(h) translating the online analytical cube from a first language to a second language different from the first responsive to display strings in the different languages in a management pack.

7. The computer-implemented framework of claim 2, further comprising the step of:
(c) utilizing the model-based multidimensional analysis services cube in a first environment by a first user and in a second environment by a second user.

8. The computer-implemented framework of claim 2, further comprising the step of:
(e) applying a named calculation to the created data source view to define a calculated attribute on a dimension.

9. The computer-implemented framework of claim 2, further comprising the step of:
(e) adding a different measure for measuring a measure group than one already associated with the multidimensional analysis services cube.

10. The computer-implemented framework of claim 2, further comprising the step of:
(e) bundling a resource containing MDXScript content to the on-line analytical processing cube; and
(f) automatically applying the MDXScript for defining a number of MDX statements to the multidimensional analysis services cube during its creation.

11. A computer-implemented method of generating a second multidimensional analysis services cube from a first model-based multidimensional analysis services cube, comprising the steps of:
(a) storing the first model-based multidimensional analysis services cube at a processor accessible by a workstation;
(b) automatically defining the second multidimensional analysis services cube from the first model-based multidimensional analysis services cube by targeting a set of facts received from the workstation; and
(c) adding dimensions to the second multidimensional analysis services cube by iterating through each fact of the set of facts.

12. The computer-implemented method of claim 11, wherein step (c) comprises adding the dimensions for each fact of the set of facts to a data source view.

13. The computer-implemented method of claim 11, wherein an XML example comprises less than four lines of XML code.

14. The computer-implemented method of claim 11, further comprising the step of:
(d) surfacing an outrigger of at least one dimension.

15. The computer-implemented method of claim 14, further comprising the step of:
(e) generating a measure group for a fact.

16. The computer-implemented method of claim 11, further comprising the step of:
(d) querying the second multidimensional analysis services cube via one of: a spreadsheet application; a content management application; a document management application; and a database management application; to create one of: a report; a scorecard; and a dashboard.

17. A computer program product comprising computer usable medium encoded in a computer having control logic stored therein including a framework for causing the computer to automatically generate a model-based multidimensional analysis services cube in extensible mark-up language and maintain the multidimensional analysis services cube responsive to changes in schema and data of data sources, said control logic comprising:
first computer readable program code means for causing the computer to create a data source comprising a data warehouse in a memory;
second computer readable program code means for causing the computer to create a data source view providing a dimension, a fact and an outrigger from the created data source;
third computer readable program code means for causing the computer to automatically create an multidimensional analysis services cube comprising at least one measure group responsive to the changes in data of the data sources; and
fourth computer readable program code means for causing the computer to display a value of a key performance indicator calculated from the multidimensional analysis services cube as a scorecard.

18. The computer program product of claim 17, further comprising:
fifth computer readable program code means for causing the computer to retrieve data at first, second and third levels of granularity for a given measured value as a drillthrough action.

19. The computer program product of claim 17, wherein the memory contains a data mart associated with the online analytical cube, further comprising:
fifth computer readable program code means for causing the computer to automatically and periodically compare each fact partition of the data mart to a partition of a measure group,
sixth computer readable program code means for causing the computer to add a missing partition to the measure group, and
seventh computer readable program code means for causing the computer to delete a partition from the measure group when the measure group no longer contains an associated fact partition, the partitions being automatically maintained by repeated comparing, adding and deleting.

20. The computer program product of claim 17, further comprising:
fifth computer readable program code means for causing the computer to mark partitions modified during updating of the online analytical cube by maintaining a batch number in a memory for added or updated data.
